(19) United States
(12) Patent Application Publication
(10) Pub. No.: US 2006/0097339 A1
(43) Pub. Date: May 11, 2006

(54) Integrated circuits including auxiliary resources

(76) Inventors: Thomas Justin Sullivan, Fort Collins, CO (US); Kuldeep S. Simha, Jayanagar (IN); Charles Corey Pie, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/985,184

(22) Filed: Nov. 10, 2004

(51) Int. Cl. H01L 29/00

(52) U.S. Cl. 257/499

(57) ABSTRACT

In one embodiment, an integrated circuit chip includes a semiconductor substrate, a metal layer formed on the semiconductor substrate, and an unused auxiliary resource that is tied to ground or to a supply voltage such that current does not flow through the resource and power is not dissipated by the resource, wherein the auxiliary resource can be tied into the integrated circuit to modify operation of the chip.

### BACKGROUND

Integrated circuit (IC) design is a complex and lengthy process that includes a range of tasks from specifying the architecture down to determining the physical placement of transistors on a silicon substrate or die. Testing is conducted during the design process to verify proper operation of the IC. For example, IC operation may be simulated using one or more software models of the IC design.

Although such simulation testing can reveal errors in the design, other errors in the design may still exist. Therefore, an error or bug may not be discovered until an actual IC chip is fabricated. Specifically, testing may be conducted on the physical IC chip that reveals an error in the chip design. In such a case, it may be necessary to redesign a portion or the entirety of the IC chip.

Due to the time and expense associated with redesigning an IC chip, it is now common practice to provide auxiliary resources on such chips that can be used to modify the chip's operation. In particular, typically thousands of additional, and initially unused, semiconductor devices, such as transistors, may be provided on the silicon die that can be electrically connected so as to achieve a desired functionality. With such resources, the die need not be redesigned, thereby saving the costs associated with such an endeavor.

Although the provision of auxiliary resources saves design time and expense, their provision can waste power. Specifically, because the auxiliary resources are connected to the supply voltage that provided power to the remainder of the IC, the auxiliary resources can leak current which results in dissipation of power. Such an arrangement is illustrated in FIG. 1. As is shown in that figure, an auxiliary resource 10 includes stacks 12 of semiconductor devices 14, such as FETs. Each device stack 12 is connected to the supply voltage (VDD) and to ground (GND) such that current leakage occurs.

Such leakage is increasing due to recent chip fabrication techniques. Accordingly, designers may be faced with the choice of unnecessarily wasting power (typically only a small fraction of the auxiliary resources are actually used), or reducing the number of auxiliary resources that are provided on the die, thereby reducing the ease and flexibility with which the operation of the IC chip can be modified.

### SUMMARY

In one embodiment, an integrated circuit chip includes a semiconductor substrate, a metal layer formed on the semiconductor substrate, and an unused auxiliary resource that is electrically connected so that current does not flow through the resource and power is not dissipated by the resource, wherein the auxiliary resource can be tied into the integrated circuit to modify operation of the chip.

### BRIEF DESCRIPTION OF THE DRAWINGS

The disclosed integrated circuits can be better understood with reference to the following drawings. The components in the drawings are not necessarily to scale.

FIG. 1 is a circuit diagram of an example of a prior art auxiliary resource.

FIG. 2 is perspective view of an embodiment of an integrated circuit chip that comprises auxiliary resources.

FIG. 3 is a partial side view of the chip of FIG. 1, illustrating various layers of the chip.

FIG. 4 is a circuit diagram of an example of an auxiliary resource of the chip shown in FIGS. 2 and 3.

FIG. 5 is a block diagram of another example of an auxiliary resource of the chip shown in FIGS. 2 and 3.

FIG. 6 is a circuit diagram of a further example of an auxiliary resource of the chip shown in FIGS. 2 and 3.

FIG. 7 is a flow diagram that illustrates an embodiment of a method for providing an auxiliary resource on an integrated circuit.

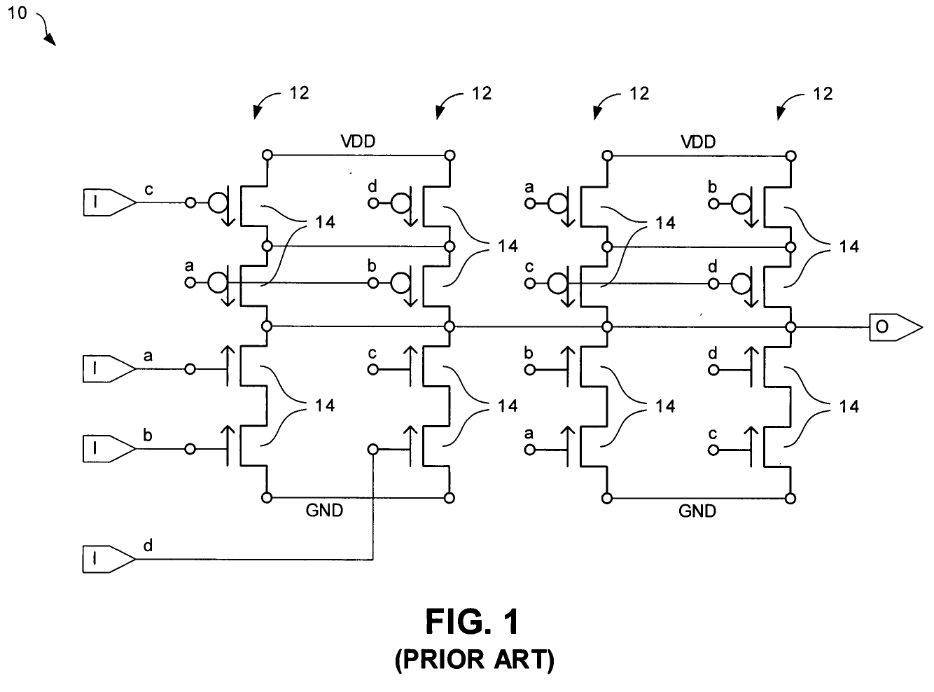

### DETAILED DESCRIPTION

As is identified above, auxiliary resources may be provided on the substrate or die of an integrated circuit (IC) chip to change the operation of the chip, for example, if a bug in the chip design is discovered. Unfortunately, however, such resources dissipate power because they are typically connected to the supply voltage, and ground and therefore leak current. As is described in the following, however, such power wasting can be reduced or even eliminated when such current leakage is reduced or prevented. As is described in the following, such a result can be achieved if each of the nodes of the auxiliary resources are connected to ground or to a supply voltage. In either arrangement, current does not flow through the resources unless and until the resources are integrated into the circuit, for example by providing a new metal layer that provides connection between the resources and the remainder of the chip components.

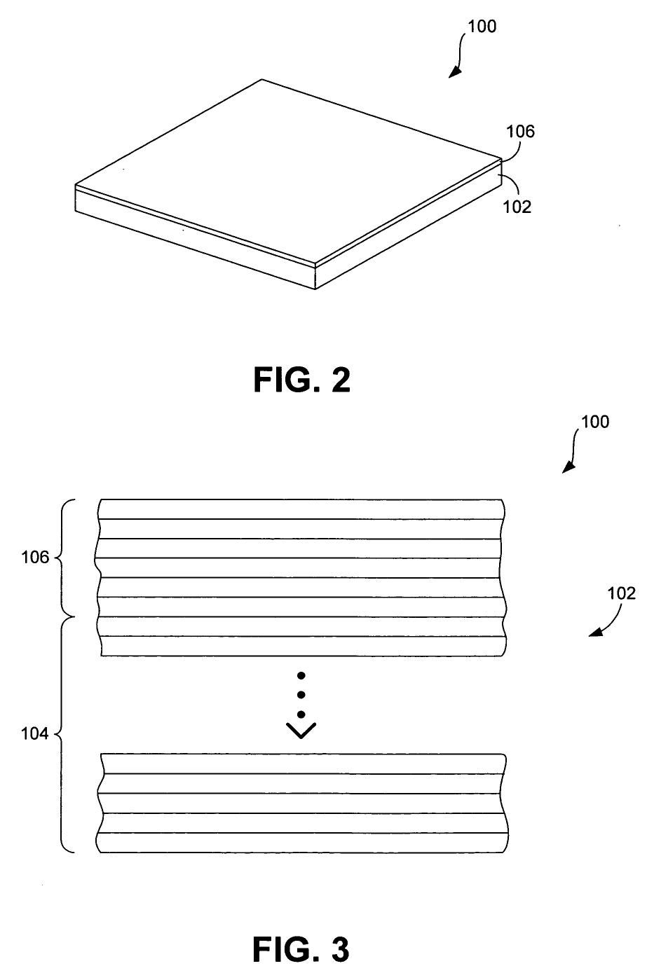

Referring now to the figures, in which like numerals designate corresponding parts, FIGS. 2 and 3 illustrate an example IC chip 100 that, for example, may comprise a microprocessor. The chip 100 generally comprises a plurality of layers of material. Specifically, the chip 100 comprises a semiconductor (e.g., silicon) substrate or die 102 that includes a plurality of semiconductor layers 104, and a plurality of metal layers 106 that are formed on top of the die. As is illustrated in FIG. 3, the example chip 100 comprises six such metal layers 106.

Provided on the die 102 are a plurality of auxiliary resources (not visible in FIG. 2 or 3). By way of example, tens of thousands of such resources may be provided on the die 102. These resources typically comprise one or more transistors, such as field-effect transistors (FETs). Although significant time and resources are normally required to change the design of the semiconductor die 102 and its various components, such as FETs, it is generally less difficult to modify the configuration of the metal layers, such as layers 106. Accordingly, it is relatively simple to leverage the auxiliary resources of the die 102 through modification of one or more metal layers 106.

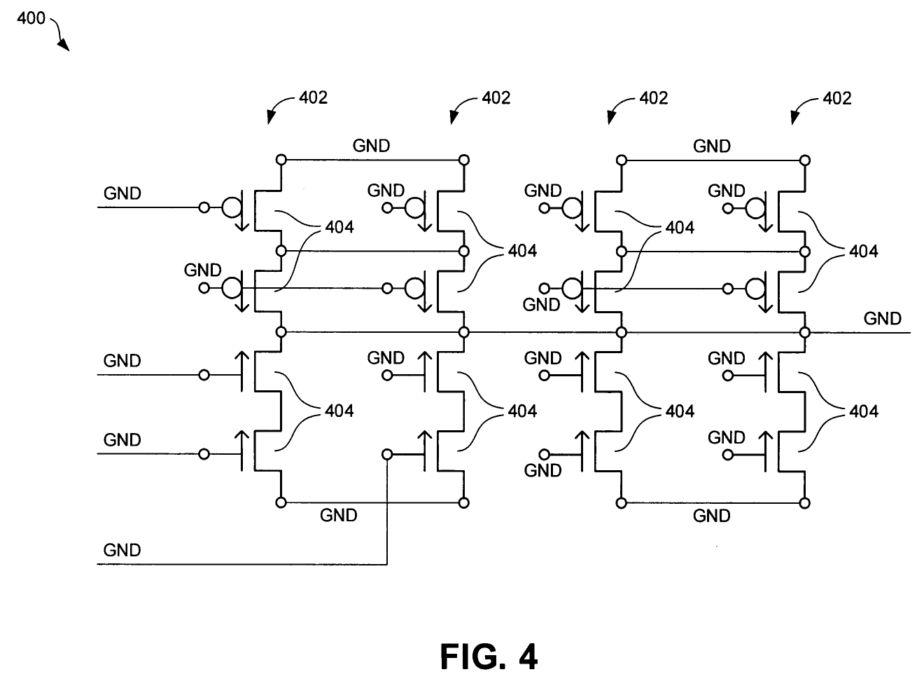

Referring now to FIG. 4, illustrated is an example auxiliary resource 400 that may be provided on the IC chip 100. The resource 400 comprises a plurality of device stacks 402 that each includes a plurality of semiconductor devices 404, such as FETs. As is indicated in FIG. 4, each gate, source, and drain of each device 404 is connected and, more particularly hard wired, to ground (GND) such that no transistor is connected to a supply voltage (VDD) as is conventional in the prior art. Accordingly, none of the devices 404 consumes power in the state shown in FIG. 4.

If it is determined at some point, for instance after testing has been conducted on the chip 100, that the functionality of the chip is to be modified, for instance to correct a bug in the chip design, an auxiliary resource can be connected as required to provide the desired functionality. For instance, the resources can be used to create AND and OR gates, NAND and NOR gates, inverters, latches, etc. To accomplish this, the auxiliary resource (e.g., resource 400) is electrically connected to the remainder of the IC to provide power to the resource and change the logic of the chip. Such connection can be achieved by adding and/or breaking conductors associated with the resource, or by reconfiguring one or more of the metal layers (e.g., layers 106).

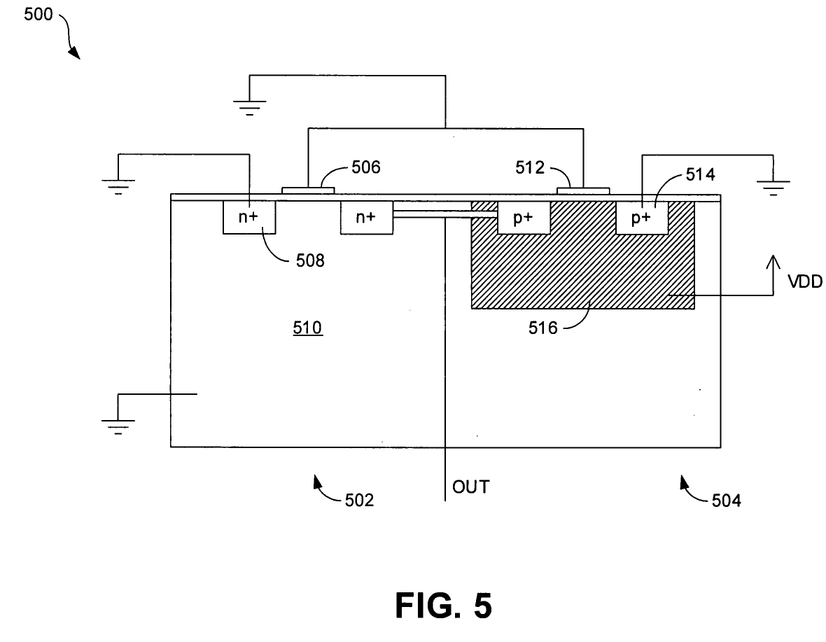

FIG. 5 illustrates another example of an auxiliary resource 500. In this example, the resource 500 comprises an inverter that includes an N-channel device 502 and a P-channel device 504. As is shown in FIG. 5, the gate 506, the source 508, and the P-substrate 510 of the N-channel device 504 each are connected to ground. The gate 512 and the source 514 of the P-channel device 504 are also connected to ground, while the N-well 516 of the P-channel device is connected to the voltage source VDD, for instance because the design of the IC at issue requires such a configuration (e.g., if the auxiliary resource 500 abuts a standard library cell). With the configuration shown in FIG. 5, no voltage is provided to the transistor gates, so as to reduce power dissipation. Although the N-well 516 is connected to VDD, significant power is not wasted given that little current can flow through the resource in this configuration.

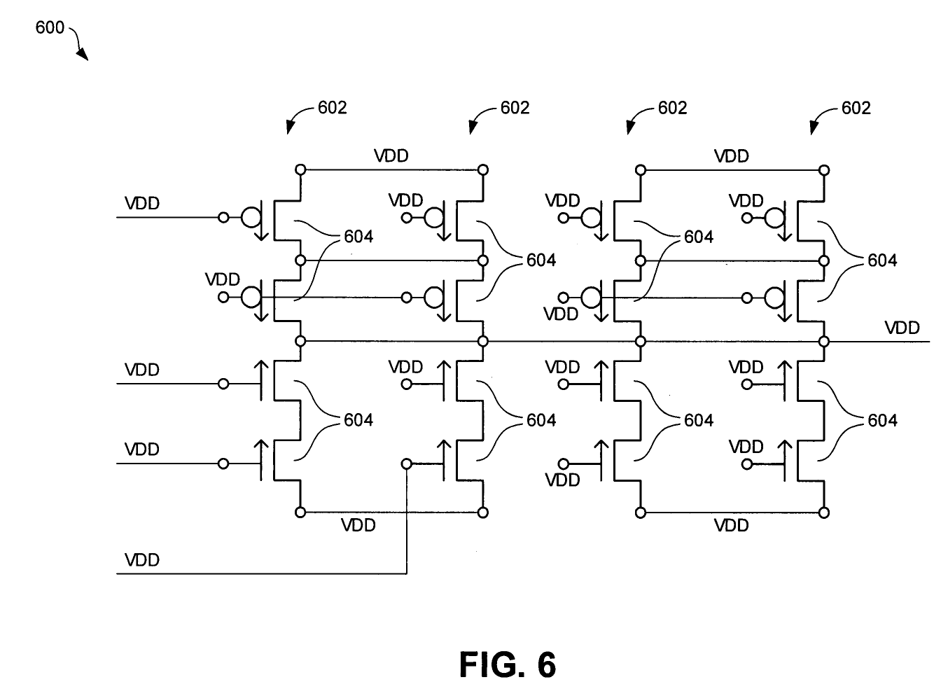

Referring next to FIG. 6, illustrated is a further example of an auxiliary resource 600 that may be provided on the IC chip 100. The resource 600 is similar to the resource 400 shown in FIG. 4. Therefore, the resource 600 comprises a plurality of device stacks 602 that each includes a plurality of semiconductor devices 604, such as FETs. In this embodiment, however, each gate, source, and drain of each device 604 is connected (hard wired) to the supply voltage (VDD) instead of ground. As with the arrangement of FIG. 4, this arrangement results in no current flowing through the devices 604 and, therefore, no power consumption in the state shown in FIG. 6.

Again, the auxiliary resource 600 can be connected to the IC to modify the operation of the chip, if desired. For instance, the auxiliary resource 600 can be electrically connected to the remainder of the IC by adding and/or breaking conductors associated with the resource, or by reconfiguring one or more of the metal layers (e.g., layers 106).

With the above-described connection arrangements, auxiliary resources provided on an IC chip dissipate little to no power when not being used. Accordingly, power wasting can be significantly reduced without the need to reduce the number of resources that are available for modifying operation of the chip. This connection scheme results in a power-saving chip having a flexible design.

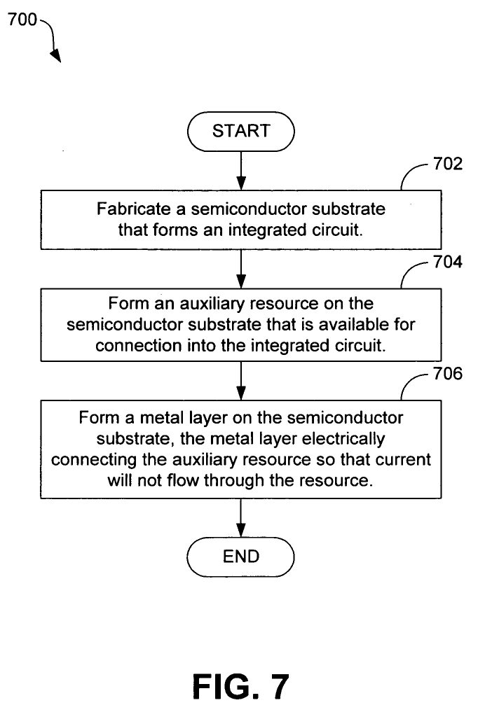

In view of the foregoing, a method can be described as provided in FIG. 7. As is indicated in that figure, the method 700 comprises fabricating a semiconductor substrate that forms an integrated circuit (702), forming an auxiliary resource on the semiconductor substrate that is available for connection into the integrated circuit (704), and forming a metal layer on the semiconductor substrate, the metal layer electrically connecting the auxiliary resource such that current will not flow through the resource (706).

What is claimed is:

1. An integrated circuit chip, comprising:
a semiconductor substrate;
a metal layer formed on the semiconductor substrate; and
an unused auxiliary resource that is electrically connected so that current does not flow through the resource and power is not dissipated by the resource;
wherein the auxiliary resource can be tied into the integrated circuit to modify operation of the chip.

2. The chip of claim 1, wherein the semiconductor substrate comprises a silicon substrate having a plurality of layers that are arranged in a stacked configuration.

3. The chip of claim 1, wherein the chip comprises a plurality of metal layers.

4. The chip of claim 1, wherein the chip comprises a plurality of auxiliary resources.

5. The chip of claim 1, wherein the chip comprises tens of thousands of auxiliary resources.

6. The chip of claim 1, wherein the auxiliary resource comprises a transistor that is provided on the semiconductor die.

7. The chip of claim 6, wherein the transistor comprises a gate, source, and drain each connected to ground.

8. The chip of claim 6, wherein the transistor comprises a gate, source, and drain each connected to a supply voltage.

9. The chip of claim 1, wherein the chip comprises a microprocessor.

10. An integrated circuit chip, comprising:
a semiconductor substrate comprising a plurality of semiconductor layers;
a plurality of metal layers formed on the semiconductor substrate;
a plurality of auxiliary resources provided on the semiconductor resource that can be used to modify operation of the chip; and
means for reducing current flow through the auxiliary resources to reduce power dissipated by the auxiliary resources.

11. The chip of claim 10, wherein the auxiliary resources comprise transistors.

12. The chip of claim 11, wherein the means for reducing power dissipated by the auxiliary resources comprise connections between gates, sources, and drains of the transistors to ground.

13. The chip of claim 11, wherein the means for reducing power dissipated by the auxiliary resources comprise connections between gates, sources, and drains of the transistors to a supply voltage.

14. The chip of claim 10, wherein the means for reducing current flow prevent substantially any current flow through the auxiliary devices.

15. An integrated circuit chip, comprising:
a silicon substrate comprising a plurality of layers that define a plurality of devices;
a plurality of metal layers formed on the silicon substrate; and
a plurality of unused auxiliary transistors that can be selectively connected to the integrated circuit to modify operation of the chip, each transistor having a gate, a source, and a drain that is each connected to ground or each connected to a supply voltage so that current does not flow through the resources and power is not dissipated by the resources.

16. The chip of claim 15, wherein the chip comprises tens of thousands of auxiliary transistors.

17. The chip of claim 15, wherein the chip comprises a microprocessor.

18. A method, comprising:
fabricating a semiconductor substrate that forms an integrated circuit;
forming an auxiliary resource on the semiconductor substrate that is available for connection into the integrated circuit; and
forming a metal layer on the semiconductor substrate, the metal layer electrically connecting the auxiliary resource such that current will not flow through the resource.

19. The method of claim 18, wherein forming an auxiliary resource comprises forming at least one transistor on the semiconductor substrate.

20. The method of claim 19, wherein forming a metal layer comprises forming a metal layer that connects a gate, a source, and a drain of the transistor to ground.

21. The method of claim 19, wherein forming a metal layer comprises forming a metal layer that connects a gate, a source, and a drain of the transistor to a supply voltage.

22. The method of claim 18, further comprising forming a new metal layer that connects the auxiliary resource to the integrated circuit so as to modify the operation of the integrated circuit.
